(19) United States
(12) Patent Application Publication
(10) Pub. No.: US 2024/0298305 A1
(43) Pub. Date: Sep. 5, 2024

(54) METHOD AND APPARATUS FOR IMPROVING STANDARD-POWER FREQUENCY BAND UTILIZATION IN WI-FI COMMUNICATIONS

(71) Applicant: MEDIATEK INC., Hsin-Chu (TW)

(72) Inventors: You-Wei Chen, San Jose, CA (US); Jianhan Liu, San Jose, CA (US); Shuling Feng, San Jose, CA (US); Yongho Seok, San Jose, CA (US); Yu-Hsien Chang, San Jose, CA (US); Thomas Edward Pare Jr., San Jose, CA (US)

(73) Assignee: MEDIATEK INC., Hsin-Chu (TW)

(21) Appl. No.: 18/592,546

(22) Filed: Mar. 1, 2024

Related U.S. Application Data
(60) Provisional application No. 63/488,197, filed on Mar. 3, 2023.

(51) Int. Cl. H04W 72/0453; H04L 5/00; H04W 84/12

(52) U.S. Cl. CPC H04W 72/0453; H04L 5/0007; H04W 84/12

(57) ABSTRACT

A Wi-Fi communication method includes: performing resource allocation for multi-user transmission orthogonal frequency division multiple access (OFDMA) according to a regulated frequency band boundary and a resource unit (RU) type, and sending information indicative of the resource allocation, where the RU type includes at least one of regular RU (rRU) and distributed-tone RU (dRU), the resource allocation indicates RUs or multiple RUs (MRUs) allocated in a channel, the channel is across the regulated frequency band boundary, and an RU or MRU allocated per user in the channel is not across the regulated frequency band boundary when using rRU.

### CROSS REFERENCE TO RELATED APPLICATIONS

This application claims the benefit of U.S. Provisional Application No. 63/488,197, filed on Mar. 3, 2023. The content of the application is incorporated herein by reference.

### BACKGROUND

The present invention relates to wireless communications, and more particularly, to a method and apparatus for improving standard-power frequency band utilization in Wi-Fi communications.

When the 6 GHz band was permitted for Wi-Fi use in the United States, the Federal Communications Commission (FCC) mandated an automated frequency coordination (AFC) system to regulate access to the 6 GHz band prior to use. An AFC database will determine the frequencies and power levels with which access points (APs) would be allowed to operate without causing interference to incumbent systems already operating in the 6 GHz band. Specifically, the FCC defines two types of device classifications with very different transmit (TX) power rules. The goal is to avoid potential interference with existing 6 GHz incumbents. Several classes of devices are defined to adapt to the Unlicensed National Information Infrastructure (UNII) bands and conditions where they are operating. For example, APs may be classified as standard-power APs and low-power APs. The low-power AP, as the name implies, has a reduced power level since it is only used indoors. The standard-power (or outdoor) AP has a serious potential with existing 6 GHz users in the geographic area. Thus, the AFC system is responsible for ensuring that any new user of the unlicensed spectrum does not impact the current services.

As AFC becomes available for Wi-Fi industry, it is desirable to maximize its utilizations in UNII bands (e.g., UNII-5 band and UNII-7 band) specified by FCC regulation. A 320 MHz bandwidth (BW320) has been defined in the 802.11be (Wi-Fi 7) standard. However, only the 320 MHz channel in UNII-5 band can be applied for standard-power with AFC. Thus, regarding the Wi-Fi communications, there is a need to fully utilize the standard-power channels in the 6 Ghz band, such as the standard-power channels in the UNII-7 band specified by FCC regulation.

### SUMMARY

One of the objectives of the claimed invention is to provide a method and apparatus for improving standard-power frequency band utilization in Wi-Fi communications.

According to a first aspect of the present invention, an exemplary Wi-Fi communication method is disclosed. The exemplary Wi-Fi communication method includes: performing resource allocation for multi-user transmission orthogonal frequency division multiple access (OFDMA) according to a regulated frequency band boundary and a resource unit (RU) type, and sending information indicative of the resource allocation, where the RU type includes at least one of regular RU (rRU) and distributed-tone RU (dRU), the resource allocation indicates RUs or multiple RUs (MRUs) allocated in a channel, the channel is across the regulated frequency band boundary, and an RU or MRU allocated per user in the channel are not across the regulated frequency band boundary.

According to a second aspect of the present invention, an exemplary Wi-Fi communication method is disclosed. The exemplary Wi-Fi communication method includes: determining a puncturing pattern of a bandwidth of a channel, wherein the bandwidth of the channel is across a regulated frequency band boundary, and the bandwidth with puncturing defined by the puncturing pattern is not across the regulated frequency band boundary; and sending a packet protocol data unit (PPDU) for a single-user transmission that is within the bandwidth with puncturing defined by the puncturing pattern.

According to a third aspect of the present invention, an exemplary Wi-Fi communication device is disclosed. The exemplary Wi-Fi communication device includes a network interface circuit and a control circuit. The control circuit is arranged to generate information indicative of a 320 MHz channel supported by an access point (AP), and instruct the network interface circuit to send a frame that carries the information indicative of the 320 MHz channel, where the 320 MHz channel is not across a boundary of an Unlicensed National Information Infrastructure (UNII) band specified by Federal Communications Commission (FCC) regulation, and the UNII band is a UNII-7 band.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system that supports the proposed standard-power frequency band utilization improvement scheme according to an embodiment of the present invention.

FIG. 2 is a diagram illustrating misalignment between defined Wi-Fi channels in the 6 GHz band and the 6 GHz unlicensed spectrum (UNII) specified by FCC regulation.

FIG. 3 is a diagram illustrating a comparison between a 52-tone dRU and a 52-tone rRU according to an embodiment of the present invention.

FIG. 4 is a diagram illustrating a case where the standard-power with AFC is employed for OFDMA transmission over RUs/MRUs in the rRU form that are allocated within the UNII-7 band specified by FCC regulation.

FIG. 5 is a diagram illustrating a first example of the proposed hybrid dRU and rRU transmission.

FIG. 6 is a diagram illustrating a second example of the proposed hybrid dRU and rRU transmission.

FIG. 7 is a diagram illustrating a third example of the proposed hybrid dRU and rRU transmission.

FIG. 8 is a diagram illustrating a power optimization scheme that applies proactive puncturing to release the maximum TX power and PSD limitations according to an embodiment of the present invention.

FIG. 9 is a flowchart illustrating a proposed method for TX power and throughput optimization according to an embodiment of the present invention.

FIG. 10 is a diagram illustrating the new Wi-Fi channelization in the 6 GHz band according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

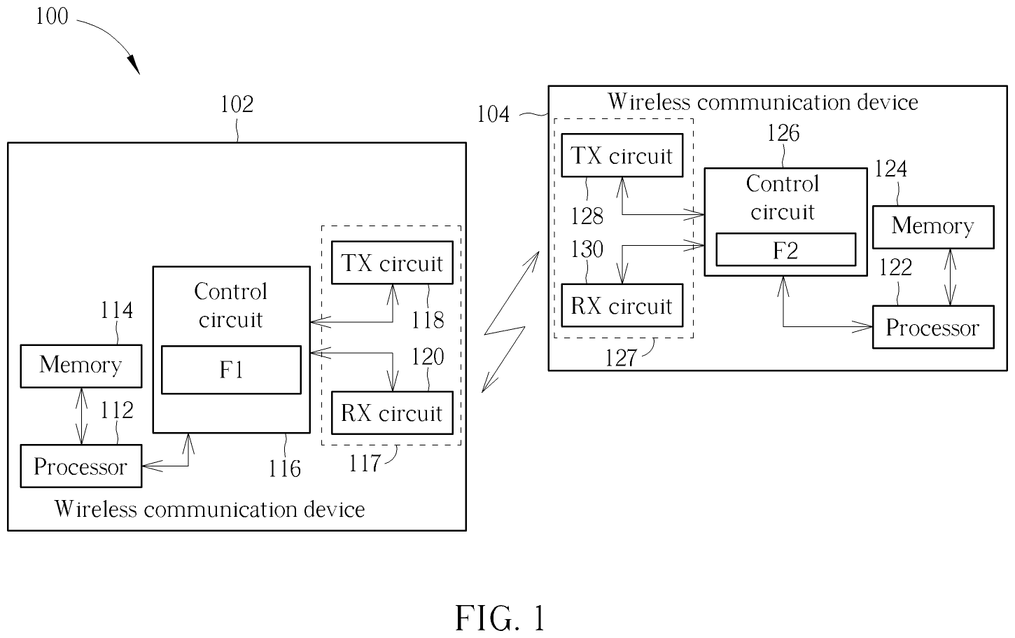

FIG. 1 is a diagram illustrating a wireless communication system that supports the proposed standard-power frequency band utilization improvement scheme according to an embodiment of the present invention. The wireless communication system 100 includes a plurality of wireless communication devices 102 and 104. For example, the wireless communication system 100 is a Wi-Fi system, including an AP and a non-AP station (STA). In one embodiment of the present invention, the wireless communication device 102 may be an AP, and the wireless communication device 104 may be a non-AP STA that is a client associated to the AP. In another embodiment of the present invention, the wireless communication device 104 may be an AP, and the wireless communication device 102 may be a non-AP STA that is a client associated to the AP. For brevity and simplicity, only two wireless communication devices 102 and 104 are shown in FIG. 1. In practice, the wireless communication system 100 is allowed to have more than two wireless communication devices, including an AP and more than one non-AP STA in the same basic service set (BSS).

The wireless communication devices 102 and 104 may have the same or similar circuit structure. As shown in FIG. 1, the wireless communication device 102 includes a processor 112, a memory 114, a control circuit 116, and a network interface circuit 117, where the network interface circuit 117 includes a transmitter (TX) circuit 118 and a receiver (RX) circuit 120. The memory 114 is arranged to store a program code. The processor 112 is arranged to load and execute the program code to manage the wireless communication device 102. The control circuit 116 is arranged to control wireless communications with the wireless communication device 104. In a case where the wireless communication device 102 is a non-AP STA and the wireless communication device 104 is an AP, the control circuit 116 controls the TX circuit 118 of the network interface circuit 117 to deal with uplink (UL) traffic between AP and non-AP STA, and controls the RX circuit 120 of the network interface circuit 117 to deal with downlink (DL) traffic between AP and non-AP STA. In another case where the wireless communication device 102 is an AP and the wireless communication device 104 is a non-AP STA, the control circuit 116 controls the TX circuit 118 of the network interface circuit 117 to deal with DL traffic between AP and non-AP STA, and controls the RX circuit 120 of the network interface circuit 117 to deal with UL traffic between AP and non-AP STA

The wireless communication device 104 includes a processor 122, a memory 124, a control circuit 126, and a network interface circuit 127, where the network interface circuit 127 includes a TX circuit 128 and an RX circuit 130. The memory 124 is arranged to store a program code. The processor 122 is arranged to load and execute the program code to manage the wireless communication device 104. The control circuit 126 is arranged to control wireless communications with the wireless communication device 102. In a case where the wireless communication device 102 is a non-AP STA and the wireless communication device 104 is an AP, the control circuit 126 controls the TX circuit 128 of the network interface circuit 127 to deal with DL traffic between AP and non-AP STA, and controls the RX circuit 130 of the network interface circuit 127 to deal with UL traffic between AP and non-AP STA. In another case where the wireless communication device 102 is an AP and the wireless communication device 104 is a non-AP STA, the control circuit 126 controls the TX circuit 128 of the network interface circuit 127 to deal with UL traffic between AP and non-AP STA, and controls the RX circuit 130 of the network interface circuit 127 to deal with DL traffic between AP and non-AP STA.

It should be noted that only the components pertinent to the present invention are illustrated in FIG. 1. In practice, the wireless communication device 102 may include additional components to achieve designated functions, and/or the wireless communication device 104 may include additional components to achieve designated functions.

The wireless communication device 102/104 supports the proposed standard-power frequency band utilization improvement scheme. Taking the FCC regulation for example, there is a 6 dB power difference and an 18 dB power spectral density (PSD) difference between standard-power and low-power classes, as shown in the following table.

TABLE 1

| | | | Maximum EIRP | |
|---|---|---|---|---|
| | | Maximum | Power Spectral | |
| Device Class | Operating Bands | EIRP | Density | |
| Standard-Power | UNII-5 | 36 dBm | 23 | dBm/MHz |
| Access Point | (5.925-6.425 GHz) | | | |
| (AFC | UNII-7 | | | |
| Controlled) | (6.525-6.875 GHz) | | | |
| Client | | 30 dBm | 17 | dBm/MHz |
| Connected to | | | | |
| Standard-Power | | | | |
| Access Point | | | | |
| Low-Power | UNII-5 | 30 dBm | 5 | dBm/MHz |
| Access Point | (5.925-6.425 GHz) | | | |
| (indoor only) | UNII-6 | | | |
| Client | (6.425-6.525 GHz) | 24 dBm | −1 | dBm/MHz |
| Connected to | UNII-7 | | | |
| Low-Power | (6.525-6.875 GHz) | | | |
| Access Point | UNII-8 | | | |
| | (6.875-7.125 GHz) | | | |

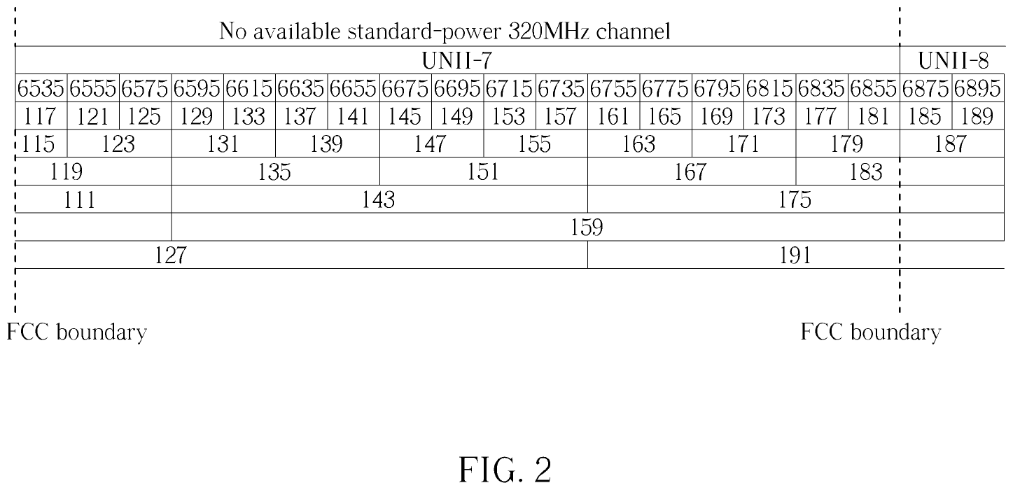

However, there is misalignment between defined Wi-Fi channels in the 6 GHz band and the 6 GHz unlicensed spectrum (UNII) specified by FCC regulation, as illustrated in FIG. 2. Currently, there is no available standard-power Wi-Fi channel with a 320 MHz bandwidth (BW320) in UNII-7 band due to the fact that all Wi-Fi BW320 channels indexed by channel numbers 127, 159, 191 (i.e., CH127, CH159, and CH191) are across the regulated frequency band boundary of the UNII-7 band specified by FCC regulation. Specifically, the Wi-Fi BW320 channel indexed by channel number 127 (i.e., CH127) is across a lower bound of the UNII-7 band, the Wi-Fi BW320 channel indexed by channel number 159 (i.e., CH159) is across an upper bound of the UNII-7 band, and the Wi-Fi BW320 channel indexed by channel number 191 (i.e., CH191) is across the upper bound of the UNII-7 band. In order to be compliant with FCC rules, any defined Wi-Fi BW320 channel that crosses the FCC defined boundary cannot use the standard-power with AFC, and has to go back to use the low-power level of the low power indoor (LPI) device.

To fully utilize the standard-power channels defined by a regulatory agency such as FCC, European Telecommunications Standards Institute (ETSI), or China regulator, the control circuit 116 of the wireless communication device (e.g., AP) 102 may perform resource allocation for multi-user transmission orthogonal frequency division multiple access (OFDMA) according to a regulated frequency band boundary and a resource unit (RU) type, and instruct the network interface circuit 117 (particularly, TX circuit 118 of network interface circuit 117) to send a frame F1 that carries information indicative of the resource allocation, where the RU type includes at least one of regular RU (rRU) and distributed-tone RU (dRU), the resource allocation indicates RUs or multiple RUs (MRUs) allocated in a channel (e.g., 320 MHz channel), the channel is across the regulated frequency band boundary, and the RU or MRU allocated per user in the channel is not across the regulated frequency band boundary. Since the resource allocation avoids assigning user's RU/MRU across the regulated frequency band boundary, the standard-power with AFC can be employed for OFDMA transmission. Specifically, when using rRU, RUS or MRUS allocated at a standard-power frequency band are transmitted with higher power spectral density (PSD) than RUs or MRUs allocated at a lower power frequency band.

In some embodiments of the present invention, the resource allocation is defined for DL transmission, and an RU or MRU of each user is allocated within the regulated frequency band boundary. For example, the RUs or MRUs defined by the resource allocation are allocated in a 6 GHz band, and the regulated frequency band boundary is the boundary (which includes an upper bound and a lower bound) of a UNII band (e.g., UNII-7 band) specified by FCC regulation. The wireless communication device 102 may act as an AP, the wireless communication device 104 may act as a non-AP STA, and the frame F1 may act as a physical-layer frame such as a multi-user (MU) packet protocol data unit (PPDU), where information indicative of the resource allocation is carried in the preamble of the DL MU PPDU. In this case, DL OFDMA can allocate each user's RU or MRU within the regulated frequency band boundary. The wireless communication device (e.g., AP) 102 properly determines the resource allocation, such that RUs/MRUs defined by the resource allocation are not across the regulated frequency band boundary. Consider a case where the 80 MHz channel (CH119) is used by the AP for MU PPDU transmission. Since the 80 MHz channel (CH119) is across the boundary of the UNII-7 band (particularly, lower bound of the UNII-7 band), the AP has to use an LPI power level. If the LPI power level is applied to the whole PPDU, only 24 dBm TX power can be achieved, where the maximum equivalent isotropically radiated power (EIRP) for LPI is 30 dBm. On the other hand, MRU allows 60 MHz transmission (RU484+RU242), and that portion is within the UNII-7 band. Hence, the AP is allowed to apply standard-power with AFC. In such a case, the TX power can be boosted.

In some embodiments of the present invention, the resource allocation is defined for UL transmission, and an RU or MRU of each user is allocated within the regulated frequency band boundary. For example, the RUs or MRUs defined by the resource allocation are allocated in a 6 GHz band, and the regulated frequency band boundary is the boundary (e.g., an upper bound or a lower bound) of a UNII band (e.g., UNII-7 band) specified by FCC regulation. The wireless communication device 102 may act as an AP, the wireless communication device 104 may act as a non-AP STA, and the frame F1 may act as a trigger frame. After being informed of the resource allocation sent from the AP via the trigger frame, the non-AP STA can send a trigger-based (TB) PPDU to the AP according to an RU/MRU allocation assigned to the non-AP STA. In this case, UL OFDMA can allocate each user's RU or MRU within the regulated frequency band boundary. The wireless communication device (e.g., AP) 102 properly determines the resource allocation, such that RUs/MRUs defined by the resource allocation are not across the regulated frequency band boundary. Consider a case where the 80 MHz channel (CH119) is used by the non-AP STA for TB PPDU transmission. Since the 80 MHz channel (CH119) is across the boundary of the UNII-7 band, the non-AP STA has to use an LPI power level. If the LPI power level is applied to the whole PPDU, the non-AP STA can use only 18 dBm TX power, where the maximum EIRP for LPI is 24 dBm. On the other hand, MRU allows 60 MHz transmission (RU484+RU242), and that portion is within the UNII-7 band. Hence, the non-AP STA is allowed to apply standard-power with AFC. In such a case, the TX power can be boosted.

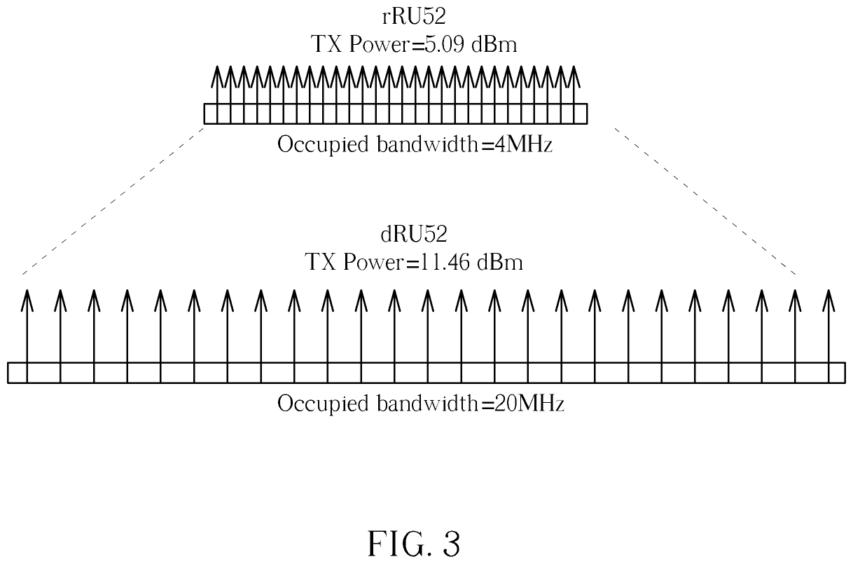

With the development of the Wi-Fi standard, distributed-tone resource unit (dRU) was proposed to enhance the TX power and therefore enhance the spectrum efficiency or extend the range. The counterpart of dRU is rRU, which is regular RU without tone spreading. Since the number of tones per MHz is reduced in dRU, the total TX power can be boosted under the same PSD limitation of counterpart rRU. FIG. 3 is a diagram illustrating a comparison between a 52-tone dRU (labeled by dRU52) and a 52-tone rRU (labeled by rRU52) according to an embodiment of the present invention. Taking a 52RU non-AP STA in LPI as an example, since 52 tones of one rRU within the 4 MHz bandwidth are spread out to the 20 MHz bandwidth, the TX power can have an around 6 dB gain.

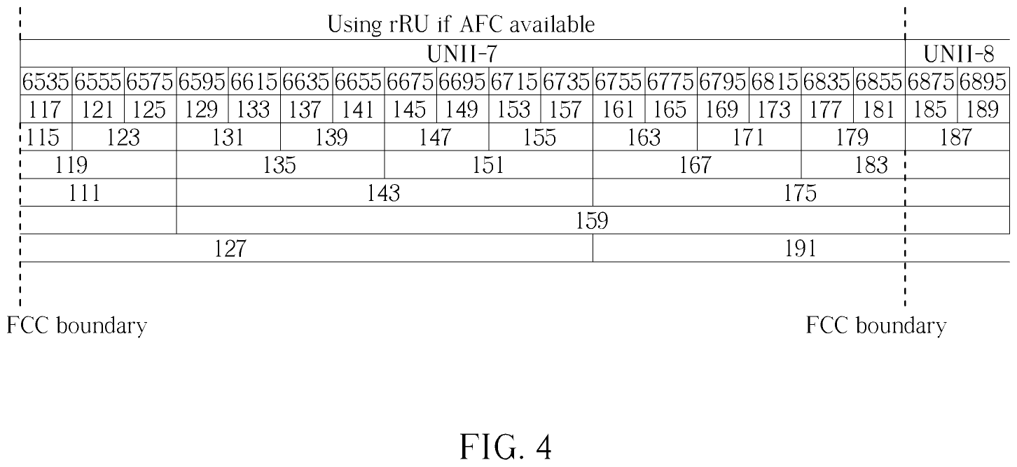

“dRU” can be applied in DL/UL non-OFDMA and OFDMA cases. There is a straightforward benefit in LPI. In some embodiments of the present invention, a Wi-Fi device with dRU capability can deliver one PPDU including RUs/MRUs in the dRU form and RUs/MRUs in the rRU form, where RUs/MRUs in the rRU form can fully utilize the standard-power channel defined by a regulatory agency (e.g., FCC, ETSI, or China regulator), and RUs/MRUs in the dRU form can utilize boosted per-tone power. For example, with the help of AFC, in the standard-power frequency band, RUs/MRUs in the rRU form can boost the TX power by 6 dB as compared to LPI. Hence, when the resource allocation is restricted for blocking RUs/MRUs in the rRU form from crossing the regulated frequency band boundary, the power utilization can be improved due to the fact that the standard-power with AFC can be employed. FIG. 4 is a diagram illustrating a case where the standard-power with AFC is employed for OFDMA transmission over RUs/MRUs in the rRU form that are allocated within the UNII-7 band specified by FCC regulation. In addition to RUs/MRUs in the rRU form, one PPDU may further include RUs/MRUs in the dRU form to further optimize the power utilization due to the fact that the TX power of RUs/MRUs in the dRU form can be boosted under the same PSD limitation of counterpart RUs/MRUs in the rRU form. In the hybrid dRU and rRU transmission case, RUs/MRUs in the dRU form are allowed to cross the regulated frequency band boundary, depending upon actual transmission data rate and TX power requirements. In addition, when RUS/MRUs in the dRU form are not across the regulated frequency band boundary, the RUs/MRUs in the dRU form may be allocated at an LPI region (i.e., a lower power frequency band).

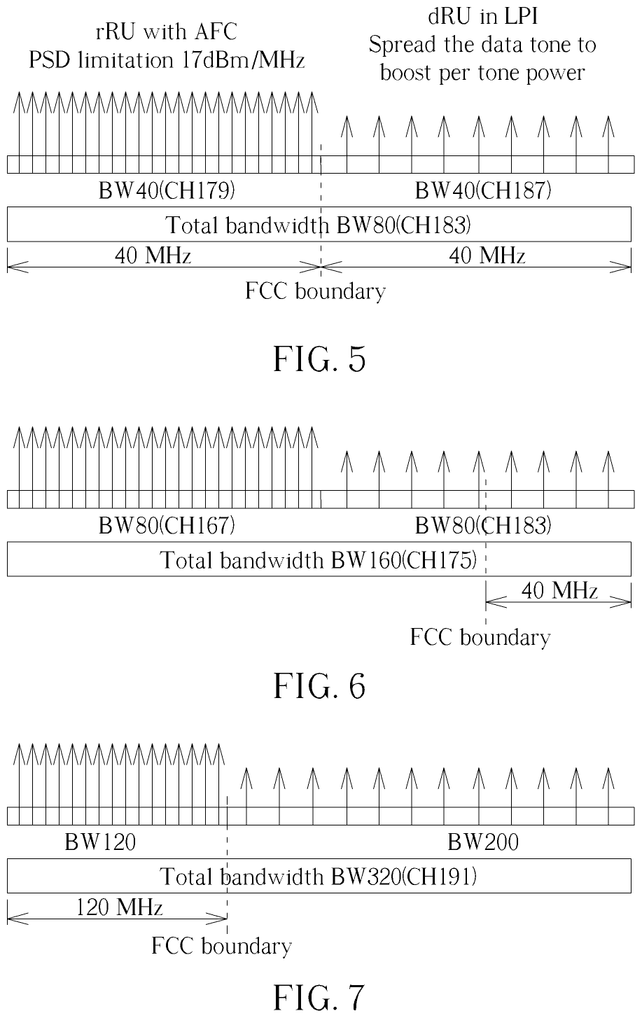

FIG. 5 is a diagram illustrating a first example of the proposed hybrid dRU and rRU transmission. In this example, the FCC boundary (e.g., upper bound of UNII-7 band) is at the center of the total available bandwidth BW80 (CH183). The resource allocation is set to allocate rRU with AFC within UNII-7 band to utilize the standard-power and allocate dRU beyond UNII-7 band to utilize the LPI power level, where tones are spread to boost per-tone power.

FIG. 6 is a diagram illustrating a second example of the proposed hybrid dRU and rRU transmission. In this example, the FCC boundary (e.g., upper bound of UNII-7 band) is 40 MHz away from the upper bound of the total available bandwidth BW160 (CH175). The resource allocation is set to allocate rRU with AFC within a first half of the available bandwidth (which is within UNII-7 band) to utilize the standard-power and allocate dRU within a second half of the available bandwidth to utilize the LPI power level, where tones are spread to boost per-tone power. Therefore, dRU will cross the FCC boundary.

FIG. 7 is a diagram illustrating a third example of the proposed hybrid dRU and rRU transmission. In this example, the FCC boundary (e.g., upper bound of UNII-7 band) is 120 MHz away from the lower bound of the total available bandwidth BW320 (CH191). The resource allocation is set to allocate rRU with AFC within the FCC boundary to utilize the standard-power with AFC and allocate dRU beyond the FCC boundary to utilize the LPI power level, where tones are spread to boost per-tone power.

As mentioned above, in order to be compliant with FCC rules, the defined Wi-Fi BW320 channel that crosses the FCC defined boundary cannot use the standard-power with AFC. In above embodiments, the present invention proposes controlling the resource allocation of RUs/MRUs to improve the standard-power frequency band utilization in the 6 GHz band. However, these are for illustrative purposes only, and are not meant to be limitations of the present invention. In an alternative design, a punctured bandwidth for UL/DL PPDU transmission can be employed to achieve the same objective of improving the standard-power frequency band utilization in the 6 GHz band.

In some embodiments of the present invention, the control circuit 116 of the wireless communication device (e.g., AP or non-AP STA) 102 may determine a puncturing pattern of a bandwidth (e.g., BW320) of a channel (e.g., CH159), and instruct the network interface 117 (particularly, TX circuit 118 of network interface circuit 117) to send a PPDU (e.g., DL PPDU or UL PPDU) for a single-user transmission that is within the bandwidth with puncturing defined by the puncturing pattern, where the bandwidth of the channel is across a regulated frequency band boundary (e.g., an upper bound or a lower bound of UNII-7 band specified by FCC regulation), and the bandwidth with puncturing defined by the puncturing pattern is not across the regulated frequency band boundary.

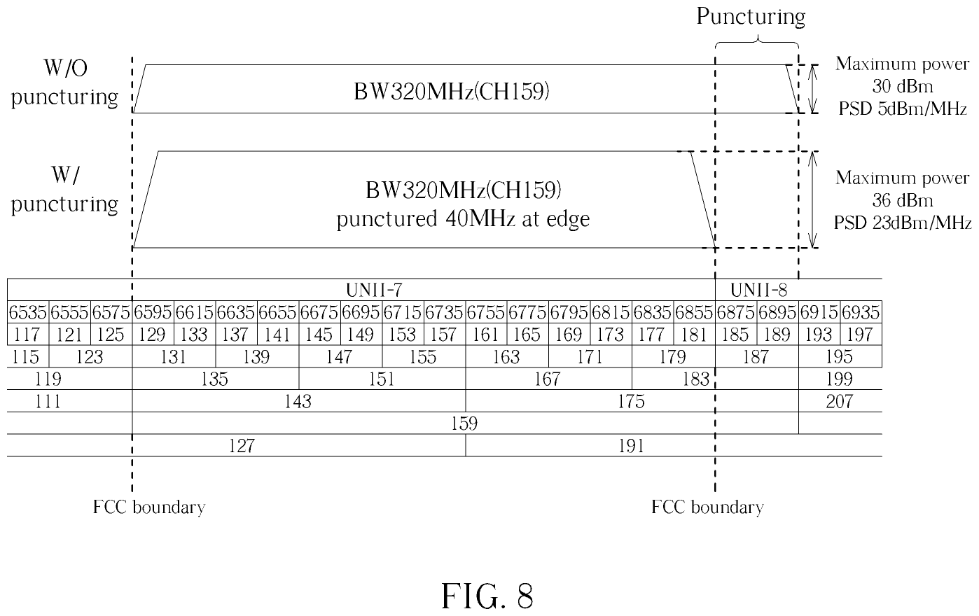

FIG. 8 is a diagram illustrating a power optimization scheme that applies proactive puncturing to release the maximum TX power and PSD limitations according to an embodiment of the present invention. Typically, punctured transmission allows the AP and the non-AP STA to carve out a slice of a channel if there is any interference, when possible, and continue to use as much of the spectrum in the channel as possible. That is, puncturing is typically used to avoid interference. In contrast to the typical puncturing, the proactive puncturing proposed by the present invention is to proactively puncture a part of the allowed bandwidth (e.g., BW320) to increase total throughput and/or TX power at the PPDU frequency band boundary. As shown in FIG. 8, the 320 MHz channel (CH159) is across the FCC boundary of UNII-7 band. Suppose that the wireless communication device 102 acts as an AP, the wireless communication device 104 acts as a non-AP STA, and the frame F1 acts as a single-user (SU) PPDU. If the AP employs an LPI power level for transmitting the SU PPDU within the 320 MHz channel (CH159), the maximum TX power is 30 dBm. In this embodiment, the AP can properly set the puncturing pattern for puncturing a 40 MHz bandwidth within UNII-8 band, and then transmit the SU PPDU within the residual 280 MHz bandwidth (i.e., bandwidth with puncturing defined by the puncturing pattern) with the TX power boosted up to 36 dBm. It should be noted that a punctured frequency subband, within a lower power frequency band, is not polluted by interference or incumbent signal; and an un-punctured frequency subband, which matches the defined puncturing pattern, has transmitted PSD that complies with standard-power regulation.

Without losing generality, 6 dB delta power can imply around 6 dB signal-to-noise ratio (SNR) difference in RX (around 2 MCS (modulation and coding scheme) difference). If the original BW320 transmission uses MCS0, with the use of the proposed proactive puncturing, the MCS used by BW280 transmission can be boosted from MCS0 to MCS2. Hence, the total throughput can be boosted from 144.1 Mbps to 378.35 Mbps, if 0.8 us guard interval (GI) is used. It should be noted that the proactive puncturing concept may be applicable for static and dynamic puncturing.

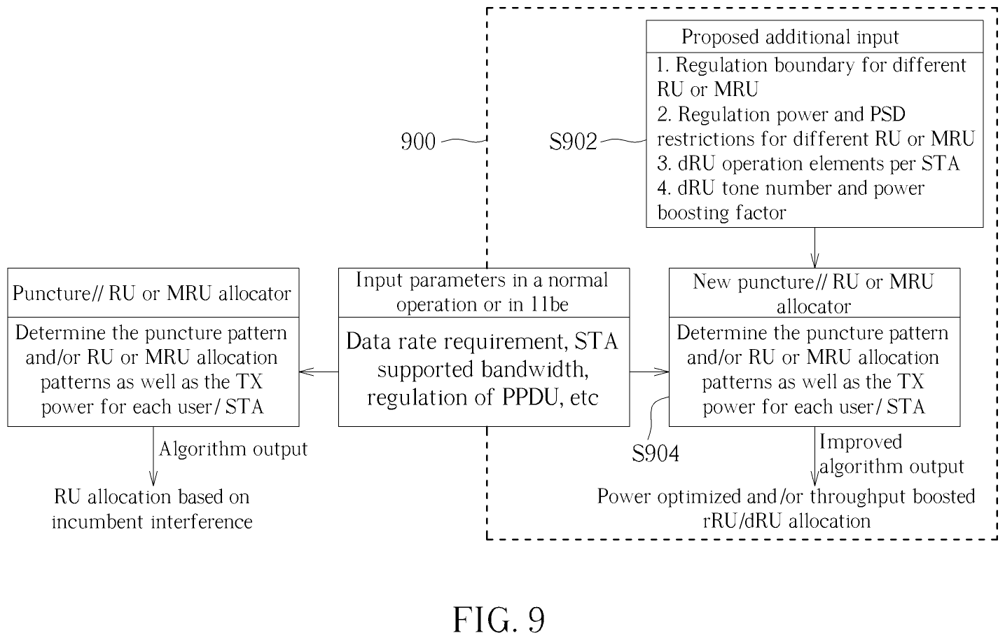

The proposed power optimization scheme relies on RU/MRU allocation and/or proactive puncturing. In a case where the wireless communication device 102 is an AP, the puncturing and RU/MRU allocator may be supported by the control circuit 102, and may receive additional parameters to optimize the TX power and throughput according to an algorithm. FIG. 9 is a flowchart illustrating a proposed method 900 for TX power and throughput optimization according to an embodiment of the present invention. At step S902, additional parameters are obtained for follow-up optimization processing. At step S904, the RU/MRU allocation (which avoids assigning user's RU/MRU across the regulated frequency band boundary) and/or the puncturing pattern (which actively punctures a part of the allowed bandwidth that is beyond the regulated frequency band boundary). In addition, the TX power for each user/STA is also determined. It should be noted that the TX power should be in compliance with rules of the regulatory agency (e.g., FCC, ETSI, or China regulator).

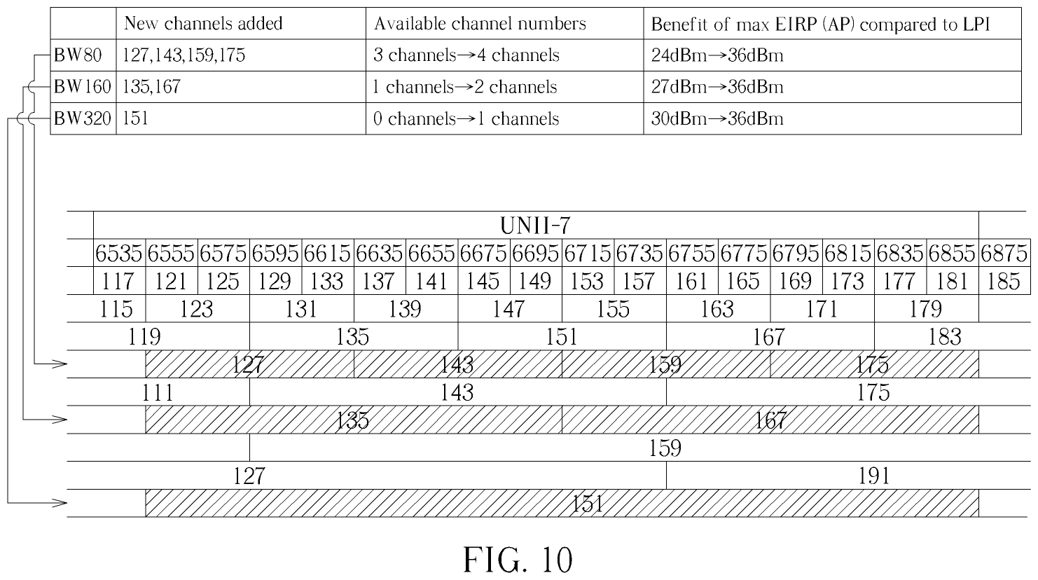

As shown in FIG. 2, there is no available standard-power Wi-Fi channel with a 320 MHz bandwidth (BW320) in the UNII-7 band due to the fact that all Wi-Fi BW320 channels (CH127, CH159, and CH191) in the common Wi-Fi channelization are across the regulated frequency band boundary of the UNII-7 band specified by FCC regulation. AFC supports standard-power for “fixed” indoor and outdoor services. The present invention further proposes new channelization used in Wi-Fi networks, which can increase the available channels numbers and the maximum TX power for fixed indoor and outdoor services. FIG. 10 is a diagram illustrating the new Wi-Fi channelization in the 6 GHz band according to an embodiment of the present invention. The proposed Wi-Fi channelization includes additional channels added to the common Wi-Fi channelization shown in FIG. 2. For example, a new 320 MHz channel (CH151), two new 160 MHz channels (CH135, CH167), and four 80 MHz channels (CH127, CH143, CH159, CH175) are added. It should be noted that all of the new channels are fully within the UNII-7 band specified by FCC regulation. Specifically, by shifting 40 MHz of channelization, a full 320 MHz bandwidth (CH151) in UNII-7 band can be achieved. Compared to using a typical 80 MHz channel operating in the LPI power level, using the new 80 MHz channel operating in the standard-power with AFC allows the TX power to boost from 24 dBm to 36 dBm. Compared to using a typical 160 MHz channel operating in the LPI power level, using the new 160 MHz channel operating in the standard-power with AFC allows the TX power to boost from 27 dBm to 36 dBm. Compared to using a typical 320 MHz channel operating in the LPI power level, using the new 320 MHz channel operating in the standard-power with AFC allows the TX power to boost from 30 dBm to 36 dBm.

For example, the wireless communication device 102 may act as an AP, the wireless communication device 104 may act as a non-AP STA, and the frame F1 may be a management frame. The control circuit 116 of the wireless communication device (e.g., AP) 102 may generate information indicative of the new 320 MHz channel (CH151) supported by the wireless communication device (e.g., AP) 102, and instruct the network interface circuit 117 (particularly, TX circuit 118 of network interface circuit 117) to send the frame F1 that caries the information indicative of the new 320 MHz channel (CH151) supported by the wireless communication device (e.g., AP) 102, where the new 320 MHz channel (CH151) is not across the regulated frequency band boundary (e.g., boundary of UNII-7 band specified by FCC regulation).

In some embodiments of the present invention, channelization switching between the common Wi-Fi channelization in the 6 GHz band as shown in FIG. 2 and the new Wi-Fi channelization in the 6 GHz band as shown in FIG. 10 may be performed. Fixed services devices can use the proposed channelization as the default setting with AFC pre-acknowledgement of its surrounding. If an AFC enrolled AP hosts both fixed and mobile clients, then it can use the common channelization as the default setting. In certain time period, AP can initial an RTS (Request to Send)/CTS (Clear to Send) protection for fixed service devices. During the protected time period, AP can trigger the fixed service devices in a Time-Division Duplexing (TDD) method or a TB PPDU, and communicate with them using the proposed new channelization. Client devices may scan Preferred Scanning Channels (PSC) in the 6 GHz band to join the BSS; however, the new proposed channelization is 40 MHz shifted, and this may cause more time to scan more channels.

If AP and non-AP STA are multi-link operation (MLO) devices, 6 GHz STA can utilize a reduced neighbor report (RNR) to discover the 6 GHz-supported AP. For example, when a non-AP STA sends a probe requests across the 2.4/5 GHz band, AP should answer a probe response and RNR information about the 6 GHz channel. If the AFC enrolled AP is running on the proposed new channelization, the fixed service clients can use the RNR info to join.

If AP and non-AP STA are multi-link operation (MLO) devices, AP can trigger per TXOP based non-AP STA switching from one link to another link if the channel is available. For example, non-AP STA originally allocated in CH187 (BW40MHZ) can be switched to CH123 (BW40MHZ). By doing that, AP should follow the Nonsimultaneous Transmit and Receive (NSTR) rule to transmit a standard-power 320 MHz PPDU.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Wi-Fi communication method comprising:
performing resource allocation for multi-user transmission orthogonal frequency division multiple access (OFDMA) according to a regulated frequency band boundary and a resource unit (RU) type, wherein the RU type comprises at least one of regular RU (rRU) and distributed-tone RU (dRU), the resource allocation indicates RUs or multiple RUs (MRUs) allocated in a channel, the channel is across the regulated frequency band boundary, and an RU or MRU allocated per user in the channel is not across the regulated frequency band boundary when using rRU; and
sending information indicative of the resource allocation.

2. The Wi-Fi communication method of claim 1, wherein when using rRU, RUs or MRUs allocated at a standard-power frequency band are transmitted with higher power spectral density (PSD) than RUs or MRUs allocated at a lower power frequency band.

3. The Wi-Fi communication method of claim 1, wherein the resource allocation is defined for uplink (UL) transmission.

4. The Wi-Fi communication method of claim 1, wherein the resource allocation is defined for downlink (DL) transmission.

5. The Wi-Fi communication method of claim 1, wherein the RUs or MRUs defined by the resource allocation are allocated in a 6 GHz band.

6. The Wi-Fi communication method of claim 1, wherein the regulated frequency band boundary is a boundary of an Unlicensed National Information Infrastructure (UNII) band specified by Federal Communications Commission (FCC) regulation, and the UNII band is a UNII-7 band.

7. The Wi-Fi communication method of claim 1, wherein one packet protocol data unit (PPDU) comprises RUs or MRUs in a rRU form, and further comprises RUs or MRUs in a dRU form that are also defined by the resource allocation.

8. The Wi-Fi communication method of claim 7, wherein the RUs or MRUs in the dRU form are across the regulated frequency band boundary.

9. The Wi-Fi communication method of claim 7, wherein the RUs or MRUs in the dRU form are not across the regulated frequency band boundary and are allocated at a lower power frequency band.

10. The Wi-Fi communication method of claim 7, wherein the regulated frequency band boundary is a boundary of an Unlicensed National Information Infrastructure (UNII) band specified by Federal Communications Commission (FCC) regulation, and the UNII band is a UNII-7 band.

11. The Wi-Fi communication method of claim 1, wherein the channel has a 320 MHz bandwidth.

12. A Wi-Fi communication method comprising:
determining a puncturing pattern of a bandwidth of a channel, wherein the bandwidth of the channel is across a regulated frequency band boundary, and the bandwidth with puncturing defined by the puncturing pattern is not across the regulated frequency band boundary; and
sending a packet protocol data unit (PPDU) for a single-user transmission that is within the bandwidth with puncturing defined by the puncturing pattern.

13. The Wi-Fi communication method of claim 12, wherein a punctured frequency subband, within a lower power frequency band, is not polluted by interference or incumbent signal.

14. The Wi-Fi communication method of claim 12, wherein an un-punctured frequency subband, which matches the defined puncturing pattern, has transmitted power spectral density (PSD) that complies with standard-power regulation.

15. The Wi-Fi communication method of claim 12, wherein the channel is in a 6 GHz band.

16. The Wi-Fi communication method of claim 12, wherein the regulated frequency band boundary is a boundary of an Unlicensed National Information Infrastructure (UNII) band specified by Federal Communications Commission (FCC) regulation, and the UNII band is a UNII-7 band.

17. The Wi-Fi communication method of claim 12, wherein the PPDU is a downlink (DL) PPDU.

18. The Wi-Fi communication method of claim 12, wherein the PPDU is an uplink (UL) PPDU.

19. The Wi-Fi communication method of claim 12, wherein the bandwidth is 320 MHz.

20. A Wi-Fi communication device comprising:
a network interface circuit; and
a control circuit, arranged to generate information indicative of a 320 MHz channel supported by an access point (AP), and instruct the network interface circuit to send a frame that carries the information indicative of the 320 MHz channel, wherein the 320 MHz channel is not across a boundary of an Unlicensed National Information Infrastructure (UNII) band specified by Federal Communications Commission (FCC) regulation, and the UNII band is a UNII-7 band.
